(19) United States
(12) Patent Application Publication
(10) Pub. No.: US 2019/0351799 A1
(43) Pub. Date: Nov. 21, 2019

(54) ARMREST FOR FIGHTER

(71) Applicant: KOREA AEROSPACE INDUSTRIES, LTD., Gyeongsangnam-do (KR)

(72) Inventors: Chang Yeon KIM, Gyeongsangnam-do (KR); Sung Min PARK, Gyeongsangnam-do (KR); Jong Joo AN, Gyeongsangnam-do (KR)

(21) Appl. No.: 16/217,282

(22) Filed: Dec. 12, 2018

(30) Foreign Application Priority Data
May 16, 2018 (KR) 10-2018-0056044

(51) Int. Cl. B60N 2/75; A47C 7/54

(52) U.S. Cl. CPC B60N 2/78; B60N 2/77; A47C 7/543; B60N 2/753; A47C 7/541; B60N 2/767

(57) ABSTRACT

Provided is an armrest for a fighter, and more particularly, an armrest for a fighter capable of allowing a pilot to control a height and an angle thereof with one hand while controlling a control stick, capable of being simply folded when not being used, and capable of maintaining a folded state even in case in which a direction of travel of the fighter is changed.

### CROSS-REFERENCE TO RELATED APPLICATIONS

This application claims priority under 35 U.S.C. § 119 to Korean Patent Application No. 10-2018-0056044, filed on May 16, 2018, in the Korean Intellectual Property Office, the disclosure of which is incorporated herein by reference in its entirety.

### TECHNICAL FIELD

The following disclosure relates to an armrest for a fighter, and more particularly, to an armrest for a fighter in which height and angle of the armrest may be controlled with one hand in the armrest on which an arm of a pilot is held when the fighter is piloted.

### BACKGROUND

In general, an armrest refers to an apparatus that is installed in the vicinity of a cockpit of a vehicle or an aircraft and holds an arm of a driver or a pilot so that the driver or the pilot takes a comfortable posture. Among places on which the armrest is installed, since a fighter has long flight times and a pilot thereof may not keep their hands off a control stick during flight time, it is important that the pilot be able to manipulate the control stick in a comfortable posture during the flight, and to this end, the armrest may be a very important apparatus.

In general, an armrest for a fighter is typically installed in the vicinity of the control stick and is installed so that the pilot may manipulate the control stick in a state in which the pilot holds the arm that controls the control stick on the armrest when the fighter is piloted. In order to be able to adjust a height of the armrest to suit physical characteristics of the pilot, the conventional armrest for a fighter is provided to include a bar having a cradle provided on an upper end thereof, a bracket fixed on an inner wall surface of a controlling room and to which the bar is slidably coupled in a vertical direction, and a fixing pin for fixing the bar to the bracket.

However, in a method of adjusting the height of such a conventional armrest for a fighter, since the pilot must fix the pin to the bracket with the other hand while maintaining a coupling height to the bracket by gripping the bar with one hand, the pilot has to use both hands. Therefore, there has been a difficulty in adjusting the height of the armrest in a state in which the fighter takes off, and the inconvenience of using both hands in the controlling room with limited space.

In addition, depending on the pilots, a holding angle of the arm that the pilots feel comfortable is different, and even in the case of the same pilot, due to the nature of the fighter, since the change of the direction of ascending and descending and the direction of travel is great, the comfortable holding angle of the arm is changed from time to time according to the direction of travel of the fighter. Nevertheless, an angle between a bottom surface of the aircraft and the cradle is fixed, which causes inconvenience in manipulation of the cockpit.

Therefore, it is necessary to develop an armrest that may easily change the height and angle during takeoff of the fighter.

### RELATED ART DOCUMENT

### Patent Document

1. Korean Patent No. 10-1593816 (“Armrest Height Controlling Apparatus”)

### SUMMARY

An embodiment of the present invention is directed to providing an armrest for a fighter that allows a pilot to control height and angle with one hand even when the pilot manipulates a control stick.

An embodiment of the present invention is directed to providing an armrest for a fighter that may be simply folded when the armrest is not intended to be used and may maintain a folded state even in a case in which a direction of travel of the fighter is changed.

Meanwhile, an object of the present invention is not limited to the above-mentioned objects. That is, other objects that are not mentioned may be obviously understood from the following specification.

In one general aspect, an armrest for a fighter includes a guide rod fixed in a controlling room, formed in a vertical direction, and having a plurality of controlling holes formed along the vertical direction; a connection member vertically slidably coupled to the guide rod along the guide rod and having a through hole communicable with the controlling holes formed therein; a controlling member provided with a holding portion on which an arm of a pilot is held on one side thereof, and having the other side formed in a tubular shape and including a coupling portion into which one side of the connection member is inserted to be movable to one side or the other side along the connection member; and a fixing pin having one end fixed in the coupling portion and the other end inserted into any one of the controlling holes through the through hole to fix a coupling position of the connection member and the controlling member with respect to the guide rod.

When the controlling member is moved to one side of the connection member, the other end of the fixing pin may be detached from the controlling hole, and the connection member and the controlling member may be vertically slidable along the guide rod, and when the controlling member is moved to the other side of the connection member, the other end of the fixing pin may be inserted into any one of the controlling holes to fix the coupling position of the connection member and the controlling member.

The armrest for a fighter may further include a return spring provided between a first spring supporting protrusion formed at a point spaced apart from one end of the fixing pin by a predetermined interval and a second spring supporting protrusion formed on one end inside the through hole of the connection member, wherein a position of the controlling member moved to one side of the connection member is returned to the other side of the connection member by a restoring force of the return spring.

The controlling member may further include a control body portion having one side coupled to the holding portion and the other side coupled to the coupling portion, and formed to close one end of the coupling portion.

A plurality of tilting grooves recessed to one side may be radially disposed inside the coupling portion of the other side surface of the control body portion, the connection member may further include a tilting protrusion protruding to one side on one end surface thereof, and when the tilting protrusion is inserted into any one of the tilting grooves, a coupling angle of the controlling member may be maintained to be constant.

The holding portion may be coupled to one side of the control body portion by a hinge and may be rotatable.

A plurality of holding portion fixing grooves may be further formed in an outer surface of one side of the control body portion along a rotation radius of the holding portion, and when a leaf spring which is partially bent is fixed on an opposite surface of the holding portion to the control body portion and the holding portion is rotated about one end portion of the control body portion, the bent portion of the leaf spring may be seated in any one of the holding portion fixing grooves to maintain an angle formed by the control body portion and the holding portion.

### BRIEF DESCRIPTION OF THE DRAWINGS

FIG. 1 is a perspective view of an armrest for a fighter according to an exemplary embodiment of the present invention.

FIG. 2 is a perspective view illustrating a figure in which a connection member is coupled to a guide rod according to an exemplary embodiment of the present invention.

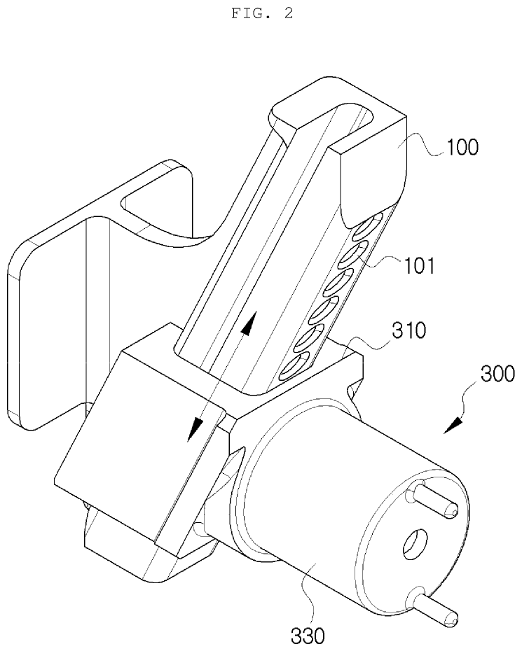

FIG. 3 is a side cross-sectional view of FIG. 2.

FIG. 4A is a side cross-sectional view illustrating a figure in which heights of a controlling member and a connection member for the guide rod are fixed according to an exemplary embodiment of the present invention.

FIG. 4B is a side cross-sectional view illustrating a figure in which the heights of the controlling member and the connection member for the guide rod are unfixed according to an exemplary embodiment of the present invention.

FIG. 5 is an exploded perspective view for describing a control of a coupling angle of the controlling member according to an exemplary embodiment of the present invention.

FIG. 6 is a perspective view illustrating a movement radius of a holding portion of the armrest for a fighter according to an exemplary embodiment of the present invention.

FIG. 7A is a side cross-sectional view illustrating a figure in which the holding portion is controlled to be horizontal with a control body portion according to an exemplary embodiment of the present invention.

FIG. 7B is a side cross-sectional view illustrating a figure in which the holding portion is controlled to be vertical with the control body portion according to an exemplary embodiment of the present invention.

### DETAILED DESCRIPTION OF MAIN ELEMENTS

10: armrest for fighter
100: guide rod
101: controlling hole
300: connection member
310: sliding portion
330: connection portion
331: through hole
333: second spring supporting protrusion
335: tilting protrusion
500: controlling member
510: control body portion
511: tilting groove
513: holding portion fixing groove
530: holding portion
531: vane
533: leaf spring
550: coupling portion
700: fixing pin
701: first spring supporting protrusion
710: return spring

### DETAILED DESCRIPTION OF EMBODIMENTS

Hereinafter, an exemplary embodiment of the present invention will be described in detail with reference to the accompanying drawings.

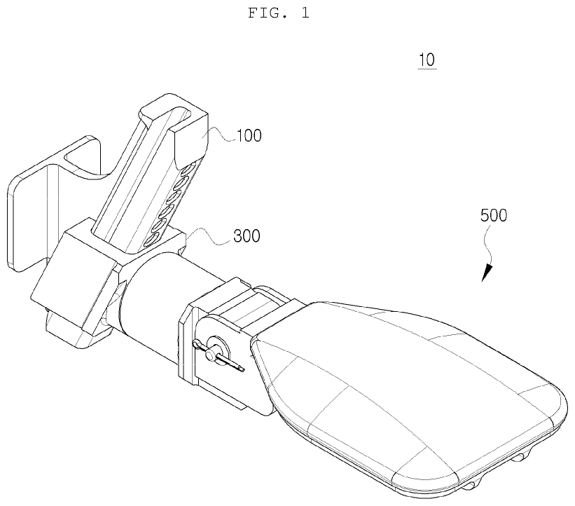

An armrest for a fighter according to an exemplary embodiment of the present invention is disposed between a cockpit and a control stick of the fighter to hold an arm of a pilot, and generally includes a guide rod 100, a connection member 300, and a controlling member 500 as illustrated in FIG. 1, in addition to a fixing pin 700 provided in the controlling member 500 which is not illustrated in FIG. 1.

The guide rod 100 is installed on a wall surface of a controlling room, in particular, on a wall surface of a control stick side based on the cockpit of the controlling room and is disposed to increase spatial efficiency of a narrow controlling room.

The guide rod 100 has a shape elongated in a vertical direction and formed to be inclined at a predetermined angle to one side, and has a shape in which a plurality of a controlling holes 101 are formed along the vertical direction.

The guide rod 100 has a connection member 300 slidably installed at one side thereof. The connection member 300 is for controlling a height of a cradle on which the arm of the pilot is held, and generally includes a sliding portion 310 and a connection portion 330. The sliding portion 310 is a portion at which the connection member 300 is vertically slidably coupled to the guide rod 100 along the guide rod 100, and the connection portion 330 is a portion to be coupled to a controlling member 500 to be described below.

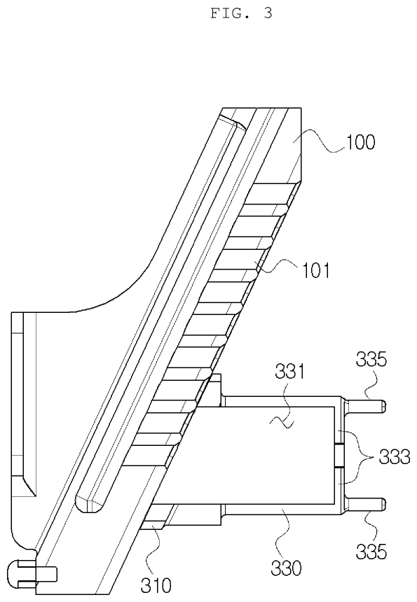

In detail, the connection portion 330 is formed to extend to one side of the sliding portion 310, and as illustrated in FIG. 3, an outer shape of the connection portion 330 is formed in a linear shape and a through hole 331 which is communicable with a controlling hole 101 of the guide rod 100 is formed in the connection portion 330. For reference, in the drawing, the outer shape of the connection portion is illustrated in the form of a rod.

A second spring supporting protrusion 333 protruding to an inner side of the through hole 331 and a tilting protrusion 335 protruding from one surface of the connection portion 330 to one side thereof are further formed on one side of the connection portion 330. Here, the second spring supporting protrusion 333 may be formed in a ring shape as illustrated to partially close one end of the through hole 331.

Each of the second spring supporting protrusion 333 and the tilting protrusion 335 is coupled to each of the fixing pin 700 and the controlling member 500 to be described below to serve to move the controlling member 500, and to fix a tilting angle at which the controlling member 500 is coupled to the connection member 300. A description of each of the second spring supporting protrusion 333 and the tilting protrusion 335 will be provided in more detail when the fixing pin 700 and the controlling member 500 are described.

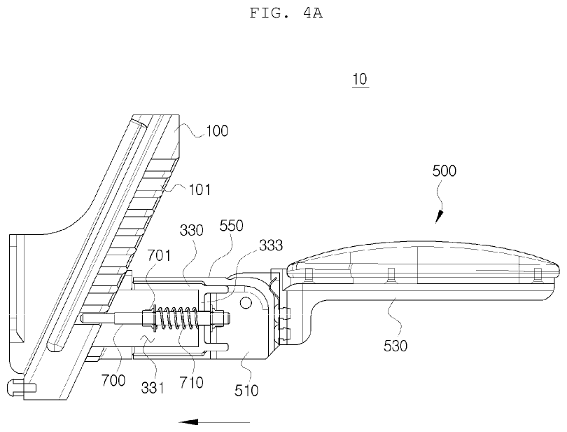

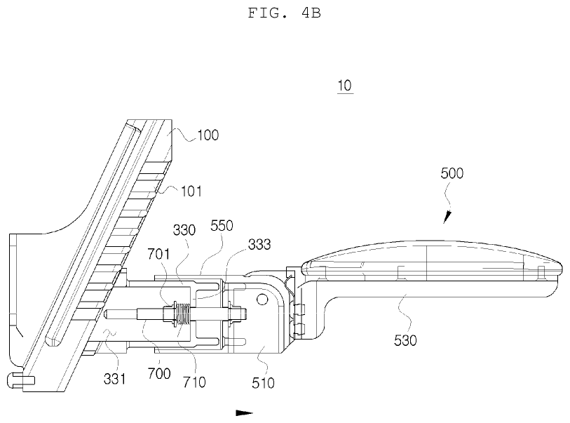

The controlling member 500 includes a control body portion 510, a holding portion 530, and a coupling portion 550, as illustrated in FIGS. 4A and 4B.

In detail, the holding portion 530 on which the arm of the pilot is held is provided on one side of the controlling member 500 with the control body portion 510 as a center, and the coupling portion 550 extending from the other side surface of the controlling member 500 to the other side thereof is provided on the other side of the controlling member 500.

The coupling portion 550 is formed in a tubular shape in which one end thereof is closed by the other side of the control body portion 510, and one side of the connection portion 330 is inserted into the coupling portion 330, such that the coupling portion 550 is coupled to the connection portion 330 to be movable to one side or the other side along an outer circumference of the connection portion 330.

In addition, one end of a fixing pin 700 is fixed in the coupling portion 550 of the other side surface of the control body portion 510.

Since the fixing pin 700 is integrally moved together as the controlling member 500 is moved to one side or the other side along the outer circumference of the connection portion 330, the fixing pin 700 determines whether or not positions of the connection member 300 and the controlling member 500 are fixed.

In detail, as illustrated in FIG. 4A, when the controlling member 500 is positioned on the other side of the connection portion 330, the fixing pin 700 fixes a coupling position in a vertical direction of the connection member 300 and the controlling member 500 for the guide rod 100 as the other end of the fixing pin 700 is inserted into any one of the controlling holes 101 through the through hole 331.

Meanwhile, a first spring supporting protrusion 701 is further formed at a point spaced apart from one end of the fixing pin 700 by a predetermined interval, and a return spring 710 is inserted between the first spring supporting protrusion 701 and the second spring supporting protrusion 333.

In a case in which the controlling member 500 is pulled to one side by external force as illustrated in FIG. 4B, the return spring 710 is contracted by the first spring supporting protrusion 701 and the second spring supporting protrusion 333, and in a case in which the external force is released, the return spring 710 is restored by a restoring force of the return spring 710 to thereby move the controlling member 500 to the other side of the connection portion 330 and to automatically insert the other end of the fixing pin 700 into the controlling hole 101.

That is, in the armrest 10 for a fighter according an exemplary embodiment of the present invention, when a pilot wishes to control a height of the holding portion 530, the pilot detaches the fixing fin 700 from the controlling hole 101 by pulling the controlling member 500 to one side in a state in which the pilot grasps the controlling member 500 with one hand, sets a height of the controlling member 500 by moving the controlling member 500 upwardly and downwardly, and then releases the hand grasping the controlling member 500. As a result, the fixing pin 700 is automatically inserted into the controlling hole 101 by the return spring 710 and the height of the holding portion 530 is controlled.

For reference, typically, fighter pilots are divided into eight groups according to the height of the pilots. As a design eye point (DEP) required for the control of the fighter is different for each group, an example posture taken by the pilot and a placement position of the cockpit are different when the fighter is piloted. For this reason, when the control stick is piloted, a portion to which a high load of the arm is applied is different for each of the groups. In addition, a change of a point with high load for each of the groups has the characteristic of appearing as an upwardly inclined linear shape.

The guide rod 100 provides a customized placement position of the holding portion 530 according to the height of the pilot by forming the guide rod 100 to be inclined at a predetermined angle to one side in consideration of the DEP as described above. That is, the holding portion 530 supports the point of the arm of a user to which the highest load is applied according to the height of the pilot.

In detail, typically, the customized placement position of the holding portion 530 is provided by considering that as the height of the pilot is smaller, the cockpit is pulled forward, so a distance between the cockpit and the armrest for a fighter becomes shorter, and that as the arm of the pilot is also positioned close to the bottom surface of the fighter, the coupling height of the connection member 300 and the controlling member 500 with respect to the guide rod 100 is controlled to be coupled to the lower side of the guide rod 100. On the contrary, in a case in which the height of the pilot is large, since the distance between the guide rod 100 and the cockpit is controlled to be large and the coupling position of the connection member 300 and the controlling member 500 with respect to the guide rod 100 is also positioned on an upper side, the holding portion 530 is automatically positioned close to the arm of the pilot by the shape characteristic of the guide rod 100 formed to be inclined to one side.

In addition, the guide rod 100 is formed to be inclined by a predetermined angle in the front of the pilot toward the upper side thereof, that is, toward a side on which the cockpit is disposed. As a result, as the height of the holding portion 530 is moved to the upper side, the holding portion 530 may be positioned in the front of the pilot. This takes into account different lengths of the arm depending on the height or size of the pilot.

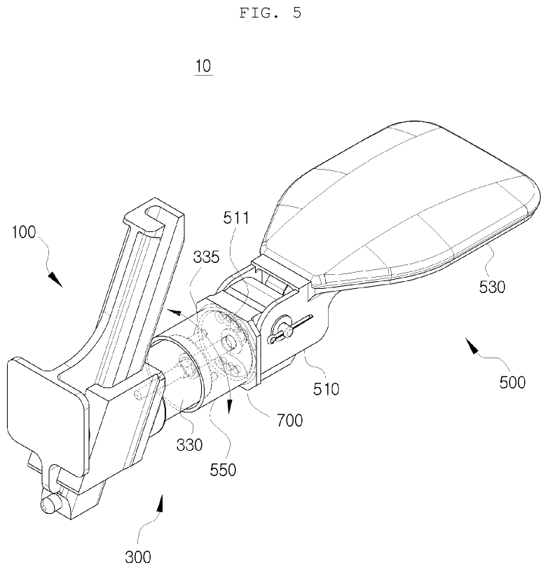

Meanwhile, a plurality of tilting grooves 511 recessed to one side may be radially disposed inside the coupling portion 550 of the other side surface of the control body portion 510 as illustrated in FIG. 5.

As the controlling member 500 is moved to the other side of the connection member 300 and is in close contact therewith, the tilting protrusion 335 formed on one end of the connection member 300 is inserted into the tilting grooves 511.

Here, since the plurality of tilting grooves 511 are radially formed as described above, the controlling member 500 may be coupled to the connection member 300 by changing a coupling angle of the controlling member 500, particularly, a tilting angle at which the connection member 300 and the controlling member 500 are coupled to each other, depending on which of the plurality of tilting grooves 511 to which the tilting protrusion 335 is coupled.

In detail, in the armrest 10 for a fighter according to an exemplary embodiment of the present invention, when the pilot wishes to change the tilting angle of the holding portion 530, in a state in which the pilot grasps the controlling member 500 with one hand and pulls the controlling member 500 to one side by a protruding length of the tilting protrusion 335, the pilot rotates the adjusting member 500 at a predetermined angle in a front-rear direction with the connection portion 330 as a center axis to control the tilting angle of the holding portion 530 and then releases the hand grasping the controlling member 500. As a result, as the other side surface of the control body portion 510 is in close contact with the one side surface of the connection portion by the return spring 710, the tilting protrusion 335 is inserted into the tilting groove 511 and the tilting angle is fixed.

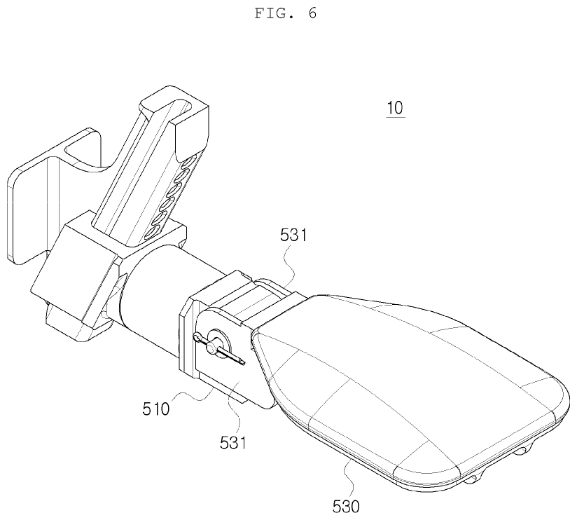

The holding portion 530 may be coupled to one side of the control body portion 510 by a hinge and may be rotatably coupled thereto as illustrated in FIG. 6.

In detail, a pair of vanes 531 surrounding front and rear side surfaces of the control body portion 510 is formed to be extended from the other end of the holding portion 530, and the pair of vanes 531 and the control body portion 510 are coupled to each other by a hinge.

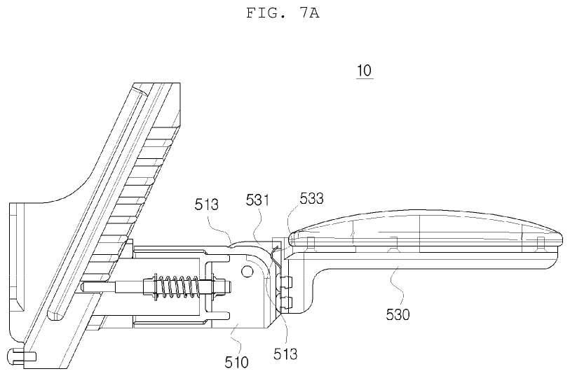

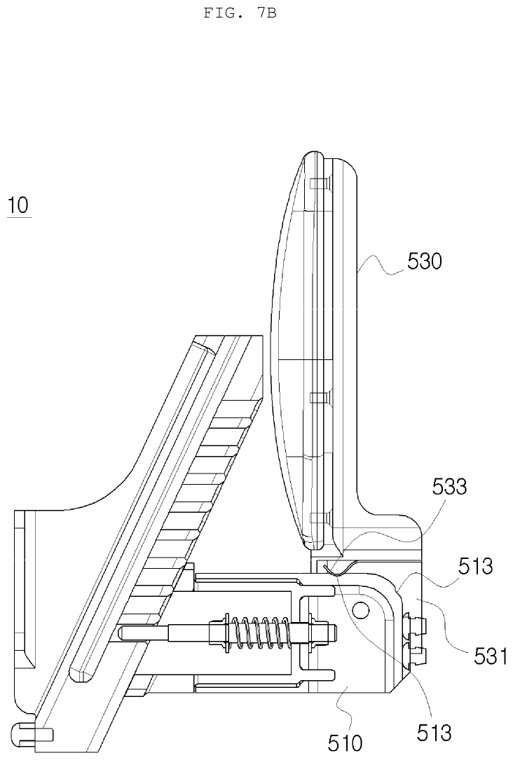

Here, as illustrated in FIGS. 7A and 7B, a plurality of holding portion fixing grooves 513 are formed in an outer surface of one side of the control body portion 510 along a rotation radius of the holding portion 530, and a leaf spring 533 which is partially bent toward the control body portion 510 is coupled to an opposite surface to the control body portion 510 positioned between the pair of vanes 531 of the other end of the holding portion 530 so as to have an inserted form.

FIGS. 7A and 7B illustrate that the holding portion fixing grooves 513 are formed in an upper surface and one side surface of the control body portion 510. As illustrated in FIG. 7A, when the holding portion 530 and the control body portion 510 are horizontal, the bent portion of the leaf spring 533 is seated in the holding portion fixing groove 513 formed in one side surface of the control body portion 510. In addition, when the holding portion 530 is controlled to be vertical with the control body portion 510 by rotating the holding portion 530, the leaf spring 533 is moved to the upper surface of the control body portion along the outer surface of one side of the control body portion 510. Here, in a section in which the bent portion of the leaf spring 533 is detached from the holding portion fixing groove 513 formed in one side surface of the control body portion 510, an interval between the control body portion 510 and the opposite surface of the control body portion 510 of the holding portion 530 becomes narrower, the leaf spring 533 is moved in a state in which it is spread at a predetermined angle. Next, as illustrated in FIG. 7B, when the holding portion 530 reaches a position perpendicular to the control body portion 510, the bent portion of the leaf spring 533 is seated in the holding portion fixing groove 513 formed in the upper surface of the control body portion 510 and is restored to an original form.

That is, the leaf spring 533 serves to elastically support the holding portion 530 to rotate only when a predetermined force or more is applied to the holding portion 530 through the structure as described above, and restrains the holding portion 530 from freely rotating even through a direction of travel of the fighter is changed during flight of the fighter, thereby preventing the holding portion 530 from rotating during flight of the fighter so as not to interfere with the control by the pilot.

The armrest for a fighter according to the present invention having the configurations as described above may have the following effects.

First, the height of the cradle may be controlled with one hand through the configuration of the fixing pin fixed to the controlling member, so that the height of the armrest may be controlled even when the fighter is piloted.

Second, the fixing pin is automatically seated in the controlling hole through the configuration of the return spring, so that the connection member and the controlling member may be stably fixed to the guide rod.

Third, the tilting angles of the controlling member and the holding portion may be controlled through the configurations of the tilting groove and the tilting protrusion, so that the arm holding angle suitable for a preference of the pilot may be provided.

Fourth, the holding portion and the control body portion are elastically supported to maintain a predetermined angle through the configurations of the holding portion fixing groove and the leaf spring even in the case in which the direction of travel of the fighter is changed, so that it is possible to prevent a problem that occurs when the holding portion is rotated and interferes with the control of the fighter.

The present invention is not to be construed as being limited to the above-mentioned exemplary embodiment. The present invention may be applied to various fields and may be variously modified by those skilled in the art without departing from the scope of the present invention claimed in the claims. Therefore, it is obvious to those skilled in the art that these alterations and modifications fall in the scope of the present invention.

What is claimed is:

1. An armrest for a fighter comprising:
a guide rod fixed in a controlling room, formed in a vertical direction, and having a plurality of controlling holes formed along the vertical direction;
a connection member vertically slidably coupled to the guide rod along the guide rod and having a through hole communicable with the controlling holes formed therein;
a controlling member provided with a holding portion on which an arm of a pilot is held on one side thereof, and having the other side formed in a tubular shape and including a coupling portion into which one side of the connection member is inserted to be movable to one side or the other side along the connection member; and
a fixing pin having one end fixed in the coupling portion and the other end inserted into any one of the controlling holes through the through hole to fix a coupling position of the connection member and the controlling member with respect to the guide rod.

2. The armrest for a fighter of claim 1, wherein when the controlling member is moved to one side of the connection member, the other end of the fixing pin is detached from the controlling hole, and the connection member and the controlling member are vertically slidable along the guide rod, and
when the controlling member is moved to the other side of the connection member, the other end of the fixing pin is inserted into any one of the controlling holes to fix the coupling position of the connection member and the controlling member.

3. The armrest for a fighter of claim 1, further comprising a return spring provided between a first spring supporting protrusion formed at a point spaced apart from one end of the fixing pin by a predetermined interval and a second spring supporting protrusion formed on one end inside the through hole of the connection member,
wherein a position of the controlling member moved to one side of the connection member is returned to the other side of the connection member by a restoring force of the return spring.

4. The armrest for a fighter of claim 1, wherein the controlling member further includes a control body portion having one side coupled to the holding portion and the other side coupled to the coupling portion, and formed to close one end of the coupling portion.

5. The armrest for a fighter of claim 4, wherein a plurality of tilting grooves recessed to one side are radially disposed inside the coupling portion of the other side surface of the control body portion,
the connection member further includes a tilting protrusion protruding to one side on one end surface thereof, and
when the tilting protrusion is inserted into any one of the tilting grooves, a coupling angle of the controlling member is maintained to be constant.

6. The armrest for a fighter of claim 4, wherein the holding portion is coupled to one side of the control body portion by a hinge and is rotatable.

7. The armrest for a fighter of claim 6, wherein a plurality of holding portion fixing grooves are further formed in an outer surface of one side of the control body portion along a rotation radius of the holding portion, and
when a leaf spring which is partially bent is fixed on an opposite surface of the holding portion to the control body portion and the holding portion rotates about one end portion of the control body portion, the bent portion of the leaf spring is seated in any one of the holding portion fixing grooves to maintain an angle formed by the control body portion and the holding portion.
